(19) United States
(12) Patent Application Publication
(10) Pub. No.: US 2025/0074235 A1
(43) Pub. Date: Mar. 6, 2025

(54) CHARGING DEVICE FOR CHARGING AN ELECTRIC VEHICLE

(71) Applicant: Siemens Aktiengesellschaft, München (DE)

(72) Inventors: Johannes Richter, Fürth (DE); Stefan Perras, Eichenau (DE); Peter Kummeth, Herzogenaurach (DE)

(21) Appl. No.: 18/822,668

(22) Filed: Sep. 3, 2024

(30) Foreign Application Priority Data
Aug. 31, 2023 (DE) 10 2023 208 391.4

(51) Int. Cl. B60L 53/37; B60L 53/16

(52) U.S. Cl. CPC B60L 53/37; B60L 53/16

(57) ABSTRACT

A charging device for charging an electric vehicle with electrical energy, includes a charging cable having a charging plug which is disposed on one end and is able to be connected to a charging connector on the electric vehicle to be charged. The charging device has a plug bracket which is configured to automatically connect the charging plug to the charging connector, or to automatically disconnect the charging plug.

### CROSS-REFERENCE TO RELATED APPLICATION

This application claims the priority, under 35 U.S.C. § 119, of German Patent Application DE 10 2023 208 391.4, filed Aug. 31, 2023; the prior application is herewith incorporated by reference in its entirety.

### FIELD AND BACKGROUND OF THE INVENTION

The invention relates to a charging device for charging an electric vehicle with electrical energy by using a charging cable having a charging plug which is disposed on one end and is able to be connected to a charging connector on the electric vehicle to be charged.

Electric vehicles (also known as electrically powered vehicles) are increasingly replacing motor vehicles with internal combustion engines. It is to be expected that not only the number of electric vehicles with drivers will increase in the future, but also the number of autonomously driving electric vehicles. The first applications will be, for example, autonomously driving taxi and shuttle vehicles. The utilization of those autonomous vehicles is a decisive factor for the profitability of the services, so that downtimes for recharging must be minimized as far as possible. That is done by using appropriate quick charging stations with direct current or alternating current. In a current manual charging process of an electric vehicle, a person performs the charging process by connecting a charging cable or a charging plug from the quick charging station to a charging connector on the electric vehicle. The flexible charging cable compensates for possible movements of the vehicle during charging, for example by persons getting in or out of the vehicle or by loading or unloading payloads.

### SUMMARY OF THE INVENTION

It is accordingly an object of the invention to provide a charging device for charging an electric vehicle, which overcomes the hereinafore-mentioned disadvantages of the heretofore-known devices of this general type and which, in particular, provides improved charging for an autonomously driving, electric vehicle.

With the foregoing and other objects in view there is provided, in accordance with the invention, a charging device for charging an electric vehicle with electrical energy by using a charging cable having a charging plug which is disposed on one end and is able to be connected to a charging connector on the electric vehicle to be charged, and a plug bracket which is specified to automatically connect the charging plug to the charging connector, or to automatically disconnect, in particular extract or decouple, the charging plug in the connected state from the charging connector.

Advantageous structural embodiments of the invention are the subject matter of the dependent claims.

The advantages achieved with the invention lie in particular in that a charging device, in particular an autonomous quick charging device, with such an additional plug bracket allows automated charging of the electric vehicle. In particular, the invention enables the charging plug to be automatically connected to a charging connector for charging, to be automatically cleared or released from the plug bracket during charging, and to be automatically found and received, in particular gripped, again by the plug bracket after completion of the charging process and released, in particular extracted, from the charging connector.

A charging device is understood in particular to mean a charging station, for example a quick charging station. The charging station can be connected to a power grid, on the one hand, and to the charging cable, on the other hand. For the automatic connection and release of the charging plug from the charging connector on the electric vehicle, the charging station is configured to be adjustable in at least one, preferably in two, three, or a plurality of spatial directions.

In a potential embodiment, the plug bracket is specified to hold an unplugged charging plug on the plug bracket. Moreover, the plug bracket can be specified to hold the charging plug on the plug bracket when connecting to the charging connector.

Furthermore, the plug bracket can be specified to clear, in particular release, the plugged-in charging plug after connecting the charging plug to the charging connector. In this way, the charging plug is decoupled from the plug bracket and held so as to be plugged in this charging connector during charging. In the cleared and plugged-in state, the charging plug is potentially connected to the charging device by way of the flexible charging cable.

In a further embodiment, the plug bracket can be specified to find as well as catch the charging plug plugged into the charging connector, and to grip and release the charging plug from the charging connector. In particular, the plug bracket is specified to automatically find, catch and grip the plugged-in charging plug and to automatically release the latter from the charging connector.

Furthermore, the plug bracket can include a coupling device which is specified to releasably hold and/or fix the charging plug. For example, the coupling device can be specified to hold the charging plug by using a form-locking connection and/or a force-locking connection. For example, the charging plug can be clamped, tensioned and/or magnetically held on the coupling device. For this purpose, the coupling device can be configured, for example, as a clamping unit, tensioning unit or a magnetic unit. In particular, the coupling device and the charging plug include mutually corresponding elements, in particular clamping elements, tensioning elements and/or magnetic elements.

In a further potential embodiment, the coupling device can be configured as a retracting mechanism, in particular an arrestor cable mechanism which, for example, includes a cable pull on which the charging plug is held loosely and flexibly on one side, and is retractably mounted on the coupling device, on the other side, and has a centering unit, in particular a centered and form-locking arrestor device, in particular an arrestor funnel, an arrestor tray or the like. It is ensured by the cable pull that the charging plug is captively held. The cable pull offers flexibility. The centering unit aligns the charging plug when the latter is received and moves it into the centering unit and holds the charging plug so as to be aligned and in a form-locking and/or force-locking manner in the centering unit, for example in a corresponding receptacle, also referred to as an arrestor receptacle.

In a further embodiment, the plug bracket can include a monitoring unit which is specified to monitor and/or find a plugged-in charging plug in terms of its plugging position. For example, the monitoring unit can include at least one camera, a radio-based monitoring unit, for example a short-range radio localization unit on an ultra-broadband basis (also for short UWB basis with UWB=ultra-wideband), or a proximity sensor unit.

For example, a camera or camera system can be utilized as a monitoring unit to find or locate the charging plug. Two separate monitoring units can also be provided, wherein one monitoring unit is provided for finding a charging connector when connecting to an electric vehicle to be charged, and a further monitoring unit is provided for following a potential movement of the plugged-in charging plug when charging the electric vehicle.

By virtue of the larger adjustment movement, the monitoring unit for finding the charging connector can in particular have a larger detection range than the further monitoring unit for following the movement of the plugged-in charging plug.

The monitoring units can be of different types. Thus, the monitoring unit for finding the charging connector and thus for monitoring a larger distance can be configured as a camera. The monitoring unit for monitoring the following of the movements of the plugged-in charging plug and thus for monitoring short distances can be, for example, a proximity sensor, in particular a capacitive proximity sensor, an inductive proximity sensor, a radio-based monitoring unit, or else a camera or the like.

At least one monitoring unit, in particular a camera, can detect and identify, for example, a shape, a marking, or a pattern on the charging plug per se. Additionally or alternatively, a further monitoring unit, in particular a camera, can detect and identify the charging connector on the vehicle. For example when a camera is used as a monitoring unit, camera images and optionally the distortions of the latter are determined by an algorithm, and the plugging position of the, in particular plugged-in, charging connector or the connecting position of a free charging connector are determined by the former in order to automatically connect the charging plug to the free charging connector. Alternatively, sensor values which are detected by corresponding sensors are used.

The respective position, in particular the plugging position and/or the connecting position, can be converted into coordinates, through the use of which then the plug bracket for automatically connecting the charging plug to the free charging connector, or for finding and releasing, in particular extracting, the plugged-in charging plug from the charging connector, is moved and aligned.

For this purpose, the charging device can include an adjustment device, for example linear actuators, angular actuators, rotary joints and/or ball joints. By actuating the adjustment device, in particular the linear actuators, angular actuators, rotary joints and/or ball joints, the plug bracket can follow the charging plug and its position during a charging process (also referred to as fine adjustment, which is provided for following a movement of the plugged-in charging plug during charging of the electric vehicle).

Alternatively or additionally, the plug bracket can be moved by using the adjustment device in the direction of the charging connector before a charging process and co-aligned with the charging connector (also referred to as coarse adjustment, which is provided for finding the non-standardized position of the charging connector on the electric vehicle).

Furthermore, after a charging process the plug bracket can be moved by using the adjustment device in the direction of the charging plug to its receptacle and moved away from the charging connector for releasing the charging plug (also referred to as infeed movement).

In order to adjust the plug bracket with or without a fixed charging plug, the plug bracket can be disposed on and fastened to a movable unit of the adjustment device. Optionally, the plug bracket per se can be movably mounted.

In other words: The adjustment device can move the plug bracket accordingly. Moving or adjusting the plug bracket ensures that if the electric vehicle moves during charging of the electric vehicle, the plug bracket automatically follows the plugging position of the charging plug and/or that the plug bracket, conjointly with the charging plug that is not plugged in but fixed to the plug bracket, can be co-aligned with the charging connector.

When the charging process is completed, the charging plug can be received by using the coupling device, for example a tensioning unit or the like, due to the automatic following of the plug bracket, and be held on and fixed to the plug bracket.

In particular, the plug bracket can be configured to be movable between an initial position and the plugging position. For example, before charging, the plug bracket is set to an initial position on the charging device. In order to plug the charging plug into the charging connector of the electric vehicle to be charged, the plug bracket can first be automatically co-aligned with the charging connector and then placed in the plugging position in order to automatically connect the charging plug to the charging connector on the electric vehicle. After completion of the charging process, and the optional retrieving and gripping and releasing of the plugged-in charging plug from the charging connector, the plug bracket can be reset to the initial position.

Due to such an adjustability and mobility of the plug bracket in the unplugged state of the charging plug, and thus in the state of the charging plug held in the plug bracket, the plug bracket can be moved freely. Likewise, by releasing the charging plug from the plug bracket in the state plugged into the charging connector, the electric vehicle with the plugged-in charging plug can be moved freely by virtue of the flexible charging cable. This allows, for example, movements resulting from, for example, loading or unloading the electric vehicle and/or people entering or exiting the vehicle during the charging process of the electric vehicle, and with the charging plug plugged in, to be flexibly compensated. In particular, by clearing the plugged-in charging plug from the plug bracket, forces resulting from the minor movements of the electric vehicle, which act on the coupling of the plugged-in charging plug and charging device, can be reduced or even avoided.

Other features which are considered as characteristic for the invention are set forth in the appended claims.

Although the invention is illustrated and described herein as embodied in a charging device for charging an electric vehicle, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, rear-elevational view of an electric vehicle at a charging device according to the invention;

FIG. 2 is a perspective view of a first exemplary embodiment for the charging device according to the invention and according to FIG. 1;

FIG. 3 is a perspective view of an example of a plug bracket with a held charging plug;

FIG. 4 is a perspective view of another example of a plug bracket with an alternative coupling device for the charging plug, which is in the released position/cleared position in relation to the plug bracket;

FIG. 5 is a perspective view of a plug bracket having another alternative coupling device for the charging plug, which is in the released position/cleared position in relation to the plug bracket;

FIG. 6 is a perspective view of the plug bracket with a fixed charging plug;

FIG. 7 is a perspective view of the plug bracket with a released charging plug;

FIG. 8 is a perspective view of the plug bracket with a free charging plug;

FIG. 9 is a perspective view of the plug bracket with a caught charging plug; and

FIG. 10 is a perspective view of the plug bracket with the charging plug fixed again.

### DETAILED DESCRIPTION OF THE INVENTION

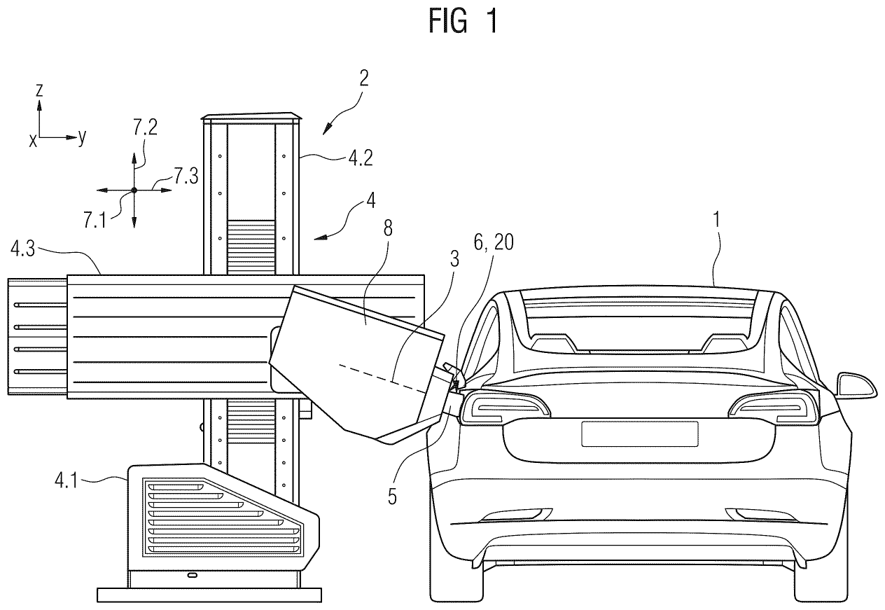

Referring now in detail to the figures of the drawings, in which mutually equivalent parts are provided with the same reference signs, and first, particularly, to FIG. 1 thereof, there is seen a diagrammatic, rear view of an electric vehicle 1 at a charging device 2 according to the invention.

The charging device 2 is configured as an autonomous charging station for charging the electric vehicle 1. The electric vehicle 1 is, for example, an autonomously driving electric vehicle, which automatically approaches the charging device 2 for charging.

The charging device 2, in particular the autonomous charging station, includes a drag chain assembly 4 for flexibly offering up of a set of cables 3 (hereinafter referred to as a cable set 3 for short) from a supply connector or power connector, which is not illustrated, in particular an earth connector, of a near or distant charging station (not shown in more detail) to a charging connector 5 of the electric vehicle 1. The charging device 2 with the drag chain assembly 4 is configured as a robotic charger, through the use of which a plug bracket 8 disposed on the drag chain assembly 4 can be variably moved, in particular in several spatial directions 7.1 to 7.3, in the direction of the charging connector 5 and/or co-aligned with the charging connector 5.

The electric vehicle 1 includes, as the charging connector 5, for example, a charging plug socket. The cable set 3, on its end facing the electric vehicle 1, includes a charging plug 6 which is configured for coupling to the charging connector 5. The charging plug 6 is shown in its plugging position 20 so as to be plugged into the charging connector 5.

The drag chain assembly 4 (also referred to as a cable guiding assembly) is in particular configured to move or transport the cable set 3 flexibly in the direction of the charging connector 5 in at least one spatial direction 7.1 to 7.3 (also referred to as a transporting direction) and to co-align the cable set 3 with the charging connector 5 of the electric vehicle 1.

Due to such a charging device 2, the cable set 3 can be flexibly moved or transported in a first spatial direction 7.1 in the longitudinal direction x, in a second spatial direction 7.2 in the vertical direction z, and/or in a third spatial direction 7.3 in the transverse direction y, over a corresponding length or a corresponding distance to the charging connector 5 of the electric vehicle 1 that has autonomously driven to the charging device 2.

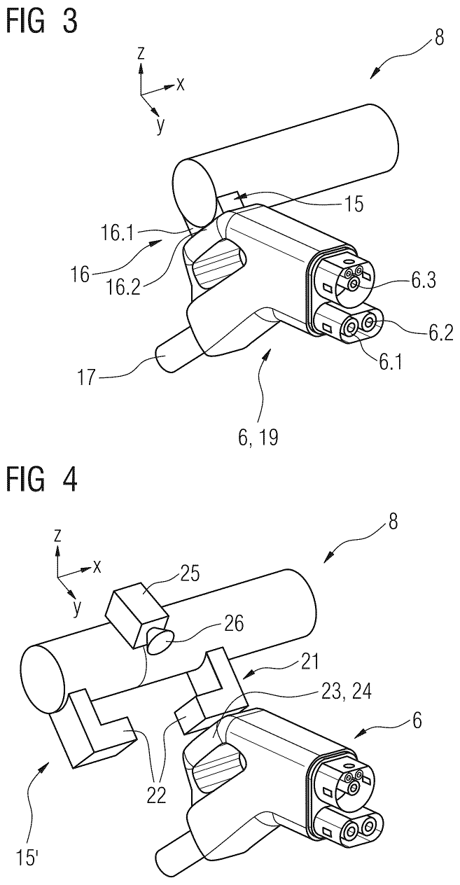

The charging device 2 is specified in such a manner that the charging plug 6 disposed on the end of the cable set 3 automatically moves to the position of the charging connector 5 of the electric vehicle 1 and is thereon co-aligned with the charging connector 5 and introduced, in particular plugged, into the charging connector 5. After completion of the charging process, the charging plug 6 can be automatically released, in particular extracted or removed, from the charging connector 5 by using the charging device 2 again. For this purpose, the charging device 2 includes the plug bracket 8 which is described in more detail with regard to FIGS. 3 to 10 below.

The charging device 2 can be universally used for different electric vehicles 1, because the cable set 3 with the charging plug 6 can be transported to the respective, usually non-standardized position of the charging connector 5 on electric vehicles 1. For example, the charging connector 5 on the electric vehicle 1 can be provided at the front, on the side or at the rear. The autonomous charging device 2, which is configured as a robotic charger, is in particular configured to automatically move the charging plug 6, for example indirectly by using the drag chain assembly 4, in the direction of an identified charging connector 5 of an electric vehicle 1 to be charged, to co-align it with this charging connector 5 and to introduce it into the latter.

In a simple embodiment, the charging device 2 is specified to move the charging plug 6 automatically to the charging connector 5 and to insert it into the latter only in the transverse direction y. Alternatively, the charging device 2 can be specified to automatically move the charging plug 6 in the longitudinal direction x for adjusting the charging plug 6 in the direction of the charging connector 5, and in the transverse direction y for inserting the charging plug 6 into the charging connector 5. Additionally, the charging device 2 can be specified to automatically move the charging plug 6 in the vertical direction z.

In the exemplary embodiment according to FIG. 1 as shown, the charging device 2 is specified to move the charging plug 6 in three spatial directions 7.1 to 7.3 in the direction of the charging connector 5.

For this purpose, the drag chain assembly 4 for each spatial direction 7.1 to 7.3 includes in each case an associated drag chain assembly 4.1 to 4.3 and the plug bracket 8 for the charging plug 6 for automatically receiving, in particular gripping, fixing and optionally releasing or clearing the charging plug 6.

A first drag chain assembly 4.1 is specified to move the cable set 3 back and forth in the longitudinal direction x. A second drag chain assembly 4.2 is specified to move the cable set 3 up and down in the vertical direction z. A third drag chain assembly 4.3 is specified to move the cable set 3 back and forth in the transverse direction y.

The third drag chain assembly 4.3 can be disposed on the second drag chain assembly 4.2 or the first drag chain assembly 4.1. The second drag chain assembly 4.2 can be disposed on the first drag chain assembly 4.1 or on the third drag chain assembly 4.3. The plug bracket 8 is disposed on the third drag chain assembly 4.3. The respective drag chain assemblies 4.1 to 4.3 are disposed and mounted so as to be movable relative to one another.

For example, the second drag chain assembly 4.2 is fastened to the first drag chain assembly 4.1 so as to be entrained for a conjoint adjustment in the longitudinal direction x. The third drag chain assembly 4.3 is fastened to the second drag chain assembly 4.2 so as to be entrained for an adjustment in the vertical direction z, and by way of this second drag chain assembly 4.2 is coupled to the first drag chain assembly 4.1 so as to be entrained for an adjustment in the longitudinal direction x. The third drag chain assembly 4.3 is additionally disposed so as to be movable relative to the second drag chain assembly 4.2 and to the first drag chain assembly 4.1 for an adjustment in the transverse direction y.

The plug bracket 8 is specified to introduce the charging plug 6 into the charging connector 5. For this purpose, the third drag chain assembly 4.3, to which the plug bracket 8 is fastened, is disposed so as to be movable relative to the second drag chain assembly 4.2 and to the first drag chain assembly 4.1 for an adjustment in the transverse direction y. In particular, the rigid or fixed plug bracket 8 is movably disposed on the third drag chain assembly 4.3, for example by using a linear actuator, an angular actuator, a rotary joint, a ball joint or the like.

The charging plug 6 is still fixedly or rigidly connected to the plug bracket 8. In order to compensate for minor vehicle movements, the plug bracket 8 is specified to release the charging plug 6 in such a way that it is plugged into the charging connector 5, on the one hand, and is connected to the charging device 2 configured as a charging station, on the other hand.

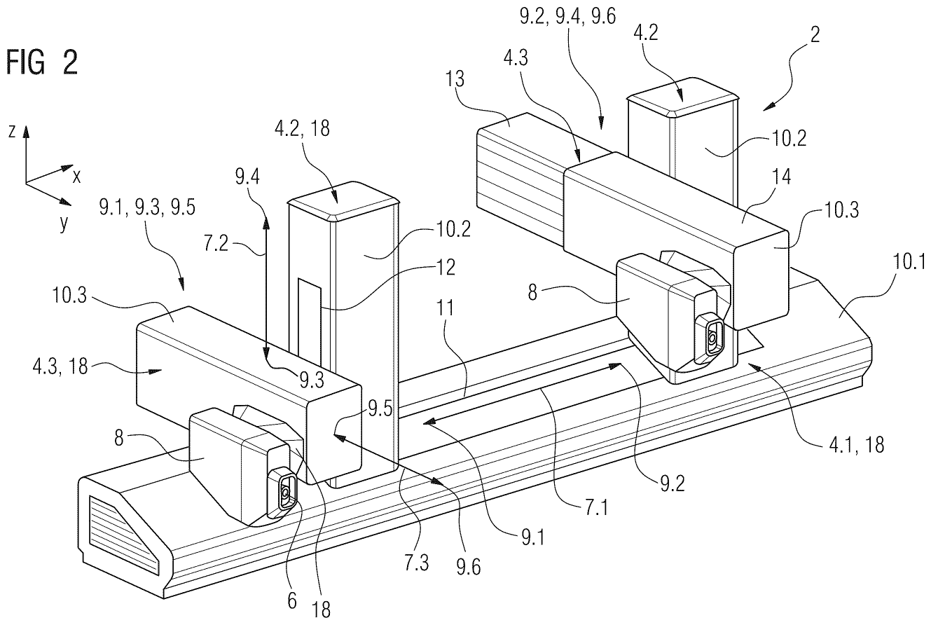

FIG. 2 diagrammatically shows the charging device 2 according to FIG. 1 in a perspective illustration.

FIG. 2 shows the charging device 2, in particular the first drag chain assembly 4.1, in its two end positions 9.1, 9.2, between which the charging plug 6 can be moved to any position in the longitudinal direction x in the first spatial direction 7.1. Furthermore, FIG. 2 shows the second drag chain assembly 4.2 in its two end positions 9.3 and 9.4, between which the charging plug 6 can be moved to any position in the vertical direction z in the second spatial direction 7.2. The third drag chain assembly 4.3 is likewise shown in its two end positions 9.5 and 9.6, between which the charging plug 6 can be moved to any position in the transverse direction y in the third spatial direction 7.3.

Preferably, the plug bracket 8 is moved by using the drag chain assembly 4 in the direction of the charging connector 5, and when reaching the longitudinal position of the charging connector 5 is aligned relative to this charging connector 5 in order to then automatically introduce the charging plug 6 into the charging connector 5 or to release or decouple it from the latter.

Optionally, the plug bracket 8 per se can be movably mounted and aligned relative to the charging connector 5 (shown in FIG. 1) and plugged into the charging connector 5, or be released or decoupled from the latter again.

The respective drag chain assembly 4.1 to 4.3 includes a housing 10.1 to 10.3.

For longitudinal adjustment of the charging plug 6, the plug bracket 8 is disposed so as to be longitudinally adjustable by way of the movably coupled drag chain assemblies 4.2 and 4.3 in a longitudinal cutout 11 of the housing 10.1 of the first drag chain assembly 4.1.

For the vertical adjustment of the charging device 2, in particular of the charging plug 6, the third drag chain assembly 4.3 is disposed so as to be vertically adjustable in a vertical cutout 12 of the housing 10.2 of the second drag chain assembly 4.2.

For the transverse adjustment of the charging device 2, in particular of the charging plug 6, the third drag chain assembly 4.3 can additionally be disposed so as to be movable in the transverse direction y relative to the second drag chain assembly 4.2 and/or first drag chain assembly 4.1. For this purpose, the housing 10.3 can include a transverse cutout in the direction of the second drag chain assembly 4.2, in a manner not illustrated in more detail.

Each of the drag chain assemblies 4.1 to 4.3 can include an associated adjustment device 18, for example a rail system, a guide system with a carriage or the like. The adjustment device 18 can include, for example, linear actuators, angular actuators, rotary joints and/or ball joints. By actuating the adjustment device 18, in particular the linear actuators, angular actuators, rotary joints and/or ball joints, the drag chain assemblies 4.1 to 4.3 can be adjusted independently of one another, or depending on one another, in one or more of the spatial directions 7.1 to 7.3, as a result of which in turn the plug bracket 8 connected to the drag chain assembly 4.3 before a charging process, during a charging process and/or after a charging process, moves the charging plug 6 and/or follows the position of a cleared and plugged-in charging plug 6, and/or the charging plug 6 can be co-aligned with the charging connector 5.

For example, the respective adjustment device 18 can include a stationary unit 13, for example, a fixed rail or a fixed guide or a fixed joint, and a movable unit 14, for example, a movable rail or a carriage or a movable joint. The respective adjustment device 18, in particular its movable unit 14, is operatively coupled for motion to a drive which is not illustrated in more detail, in particular a motor, for example an electric motor, or the like.

FIG. 3 diagrammatically shows an example for the plug bracket 8 with a charging plug 6 which is held on the plug bracket 8, in particular fixed to the latter in a form-locking and/or force-locking manner, in a perspective illustration.

The plug bracket 8 is specified to automatically connect the charging plug 6 to the charging connector 5 on the electric vehicle 1 (illustrated in FIG. 1), or to release it from the latter. In particular, the plug bracket 8 is specified in such a way that the charging plug 6 can be automatically released/cleared from the plug bracket 8, particularly when the charging plug 6 is plugged into the charging connector 5.

In addition, the plug bracket 8 can be specified to automatically release and decouple the charging plug 6 from the charging connector 5. For the automatic release and decoupling of the charging plug 6 from the charging connector 5, the charging plug 6 is held on the plug bracket 8 and is releasably fixed to the latter.

In particular, the plug bracket 8 is specified to hold the unplugged charging plug 6 on the plug bracket 8. Moreover, the plug bracket 8 can be specified to continue to hold and fix the charging plug 6 on the plug bracket 8 when connecting to the charging connector 5. In other words: When the plug bracket 8 is moved in the direction of the charging connector 5 for connecting, the charging plug 6 is entrained and automatically introduced into the charging connector 5.

For this purpose, the plug bracket 8 includes a coupling device 15 which is specified to releasably hold and/or releasably fix the charging plug 6. For example, the coupling device 15 may be specified to hold and releasably fix the charging plug 6 in a form-locking and/or force-locking manner on the plug bracket 8.

For example, the coupling device 15 can be specified to releasably hold and releasably fix the charging plug 6 in a clamped, tensioned and/or magnetic manner or by using a cable pull, in particular an arrestor cable pull, or the like on the plug bracket 8.

For this purpose, the coupling device 15 can be configured, for example, as a magnetic unit 16, which has at least one magnetic element 16.1 on the plug bracket 8 and one magnetic counter-element 16.2 on the charging plug 6. In order to release the charging plug 6 from the plug bracket 8, the magnetic element 16.1 and the magnetic counter-element 16.2 can be controlled and activated or deactivated accordingly.

The charging plug 6 has at least one charging plug contact 6.1 for a charging cable 17 which includes the set of cables 3 (illustrated in FIG. 1). Optionally, the charging plug 6 can have additional plug contacts 6.2, 6.3, for example for protective conductors, communication lines, signal lines, control lines, supply lines or the like, which are additionally provided in the set of cables 3.

In comparison to known fixed couplings of the plug bracket 8 and the charging plug 6, the releasable coupling of the plug bracket 8 and the charging plug 6 allow damage due to small vehicle movements during charging of the electric vehicle 1 to be able to be avoided, since these movements can be compensated due to the decoupling action.

FIG. 3 shows the charging plug 6 in its initial position, in which the charging plug 6 is held on and fixed to the plug bracket 8.

The adjustment device(s) 18 of the drag chain assembly 4 can accordingly move the plug bracket 8 in particular between the initial position, in which the charging plug 6 is releasably fixed to and releasably held on the plug bracket 8, and the plugging position 20 in which the charging plug 6 is introduced into the charging connector 5 (illustrated in FIG. 1).

The movement or adjustment of the plug bracket 8 ensures that in the event of movements of the electric vehicle 1, for example during the charging of the electric vehicle 1, the plug bracket 8 can automatically follow the plugging position 20 of the charging plug 6 and/or that the plug bracket 8 with the charging plug 6, which is unplugged but fixed to the plug bracket 8 (=initial position), can be co-aligned with the charging connector 5.

FIG. 4 diagrammatically shows another example of the plug bracket 8 with an alternative detachable coupling device 15′ for the charging plug 6, which is illustrated in the released or cleared position. This means that the charging plug 6 is released from the plug bracket 8 and cleared.

The coupling device 15′ is configured, for example, as a clamping unit 21 with adjustable clamping elements 22, in particular clamping arms, clamping hooks or the like, which, for example, enable a form-locking connection with the opposite side. The charging plug 6 includes a clamping bracket 24 as a clamping counter-element 23.

Furthermore, the plug bracket 8 can include a monitoring unit 25 which is specified to monitor and/or find a plugged-in charging plug 6 in terms of its plugging position 20 (illustrated in FIG. 1). For example, the monitoring unit 25 can be at least one camera 26. Alternatively or in addition, not illustrated in more detail, the monitoring unit 25 can also include a radio-based alignment unit, for example a near-range radio localization unit on an ultra-broadband basis (also for short UWB basis with UWB=ultra-wideband), or a proximity sensor unit.

In particular, two separate cameras 26 or two separate image recognition systems can be provided: one of the cameras 26 can be provided for identifying the charging connector 5 (also referred to as charging socket), and the other camera 26 for retrieving the charging plug 6.

The camera(s) 26 can be specified, for example, to detect and identify a marking or a pattern on the charging connector 5 for the charging plug 6 and/or on the charging plug 6 per se. Camera images and optionally their distortions are determined by an algorithm, and the plugging position 20 of the plugged-in charging plug 6 is determined on the basis of the former. This enables retrieving and following of the charging plug 6 plugged into the charging connector 5 and cleared by the plug bracket 8, even during movements of the electric vehicle 1 to be charged.

Additionally, the camera(s) 26 can be specified, for example, to determine the connecting position of a free charging connector 5 for automatically connecting the charging plug 6 to the free charging connector 5 (illustrated in FIG. 1). The camera(s) 26 allow(s) readjustment and visual identification.

The respective position, in particular the plugging position 20 and/or the connecting position, can be converted into coordinates through the use of which the plug bracket 8 is then moved and/or aligned for the automatic alignment and connection of the charging plug 6 to the free charging connector 5, or for retrieving and releasing the plugged-in charging plug 6 from the charging connector 5.

Instead of the camera 26, other monitoring units 25, for example sensors for determining the position of the charging plug 6 and/or the free charging connector 5, can be provided.

After the automatic release or clearing of the charging plug 6 from the plug bracket 8, the charging cable 17 (illustrated in FIG. 3) is held significantly on the charging device 2 configured as a charging station or robotic charger. As a result, minor vehicle movements when charging the electric vehicle 1 can be compensated by the freely suspended charging cable 17.

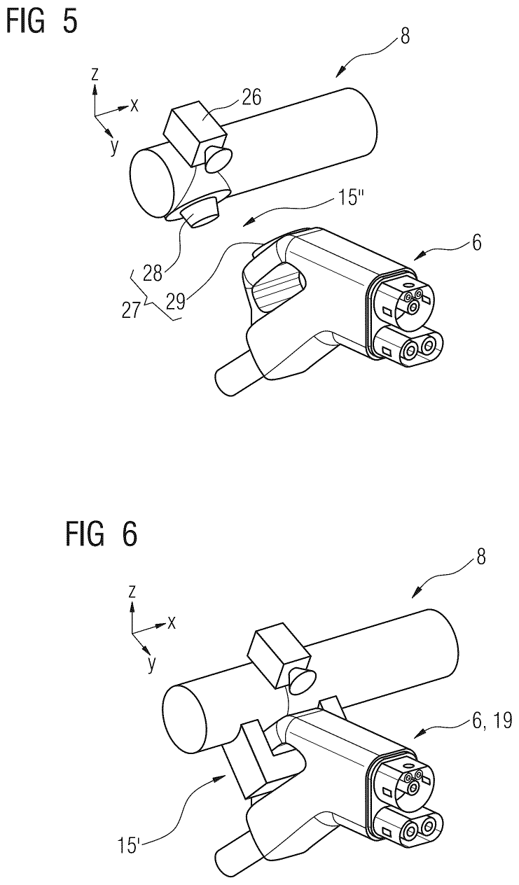

FIG. 5 diagrammatically shows another example of the plug bracket 8 with another alternative detachable coupling device 15″ for the charging plug 6, which is set to a free or released position.

The coupling device 15″ is disposed, for example, as a tensioning unit 27 with a tensioning bolt 28 on the plug bracket 8 and a clamping mount 29 on the charging plug 6.

Instead of the coupling devices 15, 15′ and 15″ described above, other devices for releasing and fixing can also be provided, such as, for example, a gripper, a zero point clamping system, a locking bolt, a magnetic interlock or the like.

FIG. 5 likewise shows the camera 26 as a monitoring unit 25 for following the movement of a plugged-in charging plug 6.

FIG. 6 diagrammatically shows the plug bracket 8 with the charging plug 6 fixed thereto, in a perspective illustration. The charging plug 6 is held and fixed in its initial position on the plug bracket 8 by using the coupling device 15. In this coupled position, the “unplugged” charging plug 6 can be co-aligned with the charging connector 5 by using the movable plug bracket 8, and automatically inserted into the charging connector.

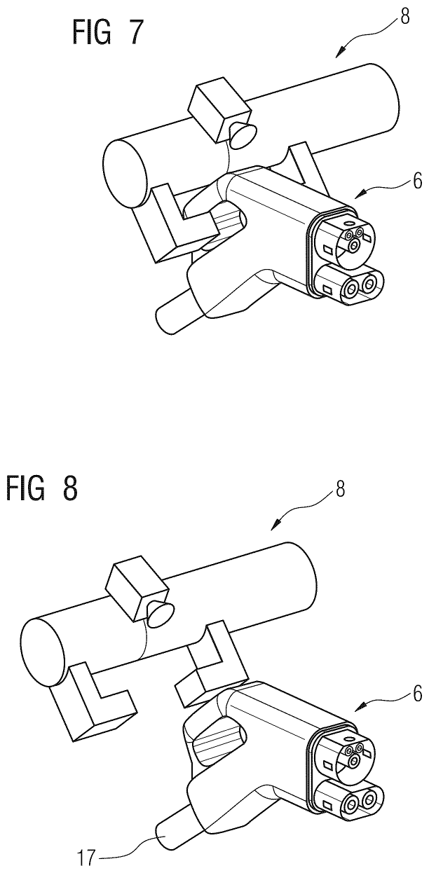

FIG. 7 diagrammatically shows the plug bracket 8 with the charging plug 6 released after coupling to the charging connector 5 (not shown here for improved clarity, but shown in FIGS. 1 and 2), in a perspective illustration. For this purpose, the plug bracket 8 is specified to clear or release the plugged-in charging plug 6 after connecting the charging plug 6 to the charging connector 5.

FIG. 8 diagrammatically shows the plug bracket 8 with the released and thus free charging plug 6, in a perspective illustration. The charging plug 6 is decoupled from the plug bracket 8 and held so as to be plugged into the charging connector 5 (not illustrated) during charging. This decoupling and cancelling of the rigid connection between the plug bracket 8 and the charging plug 6, and the flexibility of the charging cable 17, allow vehicle movements during charging of the electric vehicle 1 to be easily compensated. In an embodiment of the coupling device 15 as an arrestor cable pull mechanism, the charging plug 6 can additionally be suspended on the arrestor cable.

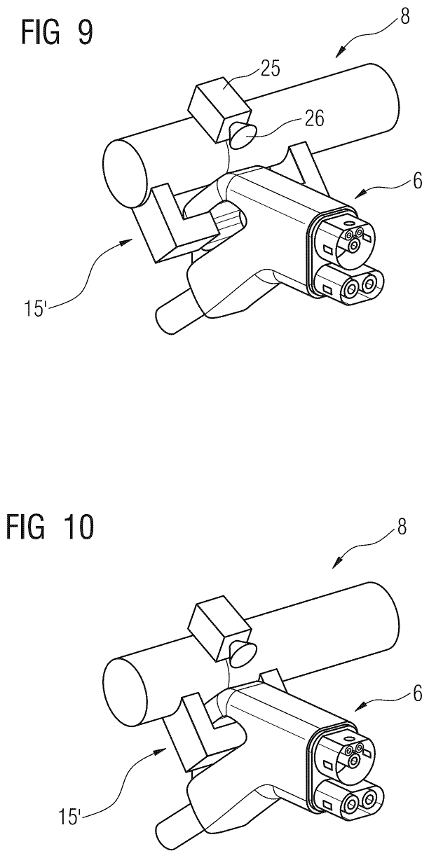

FIG. 9 diagrammatically shows the plug bracket 8 after charging and when catching or retrieving the charging plug 6 still plugged into the charging connector 5 (illustrated in FIG. 1), in a perspective illustration. Through the use of the monitoring unit 25 which is configured, for example, as a camera 26, a potential movement of the charging plug 6 which is decoupled from the plug bracket 8 and plugged into the charging connector 5 is monitored and followed. If such a movement occurred, the plug bracket 8 is automatically guided by using the adjustment device 18 in the direction of the plugged-in charging plug 6 and co-aligned with this plugged-in charging plug 6—this procedure is also referred to as finding and retrieving. The charging plug 6 is then gripped by the plug bracket 8, in particular the coupling device 15, and is extracted from the charging connector 5 and thus decoupled from the latter.

FIG. 10 diagrammatically shows the plug bracket 8 with a charging plug 6 that has been fixed again, in a perspective illustration.

After gripping the charging plug 6 and decoupling the charging plug 6 from the charging connector 5, the charging plug 6 is releasably reconnected to the plug bracket 8 by using the coupling device 15.

While the invention has been illustrated and described in more detail by referring to preferred exemplary embodiments, the invention is not restricted by the disclosed examples and other variations may be derived therefrom by a person skilled in the art without departing from the scope of protection of the invention.

Regardless of the grammatical gender of a particular term, people with male, female, or other gender identities are included.

The following is a summary list of reference numerals and the corresponding structure used in the above description of the invention:
1 Electric vehicle
2 Charging device
3 Set of cables (cable set)
4 Drag chain assembly
4.1 to 4.3 Drag chain unit
5 Charging connector
6 Charging plug
6.1 Charging plug contact
6.2, 6.3 Additional plug contacts
7.1 to 7.3 Spatial direction
8 Plug bracket
9.1 to 9.6 End position
10.1 to 10.3 Housing
11 Longitudinal cutout
12 Vertical cutout
13 Stationary unit
14 Movable unit
15, 15′, 15″ Coupling device
16 Magnetic unit
16.1 Magnetic element
16.2 Magnetic counter-element
17 Charging cable
18 Adjustment device
20 Plug-in position
21 Clamping unit
22 Clamping element
23 Clamping counter-element
24 Clamp
25 Monitoring unit
26 Camera
27 Tensioning unit
28 Tensioning bolt
29 Clamping mount
x Longitudinal direction
y Transverse direction
z Vertical direction

1. A charging device for charging an electric vehicle with electrical energy, the charging device comprising:
a charging cable having an end;
a charging plug disposed on said end of said charging cable, said charging plug configured to be connected to a charging connector on the electric vehicle to be charged; and
a plug bracket configured to automatically connect said charging plug to the charging connector or to automatically disconnect said charging plug in a connected state.

2. The charging device according to claim 1, wherein said plug bracket is configured to hold said charging plug in an unplugged state on said plug bracket.

3. The charging device according to claim 1, wherein said plug bracket is configured to hold said charging plug on said plug bracket when connecting said charging plug to the charging connector.

4. The charging device according to claim 1, wherein said plug bracket is configured to release said charging plug in a plugged-in state after connecting said charging plug to the charging connector.

5. The charging device according to claim 1, which further comprises an adjustment device and a monitoring unit interacting with one another and configured to monitor said charging plug in connected and cleared states.

6. The charging device according to claim 5, wherein said adjustment device and said monitoring unit interact with one another to follow said charging plug plugged into and cleared at the charging connector.

7. The charging device according to claim 1, wherein said plug bracket is configured to receive or grip said charging plug in a plugged-in state and to release or extract said charging plug from the charging connector.

8. The charging device according to claim 1, wherein said plug bracket includes a coupling device configured to at least one of releasably hold or fix said charging plug.

9. The charging device according to claim 8, wherein said coupling device is configured to hold and fix said charging plug in at least one of a form-locking or force-locking manner.

10. The charging device according to claim 1, wherein said plug bracket includes a monitoring unit configured to at least one of monitor or find said charging plug in a plugged-in state in terms of its plugging position.

11. The charging device according to claim 1, wherein said plug bracket is configured to be movable between an initial position and a plugging position.
